(19) United States
(12) Patent Application Publication
(10) Pub. No.: US 2013/0093683 A1
(43) Pub. Date: Apr. 18, 2013

(54) EXTERNAL CONTROL SYSTEM FOR TOUCH DEVICE AND METHOD USING THE SAME

(71) Applicants: CHUNG-CHENG HU, NEW TAIPEI CITY (TW); DER-WEI LU, NEW TAIPEI CITY (TW); CHYI-PYN PENG, NEW TAIPEI CITY (TW); KENG-JUI CHANG, NEW TAIPEI CITY (TW)

(72) Inventors: CHUNG-CHENG HU, NEW TAIPEI CITY (TW); DER-WEI LU, NEW TAIPEI CITY (TW); CHYI-PYN PENG, NEW TAIPEI CITY (TW); KENG-JUI CHANG, NEW TAIPEI CITY (TW)

(73) Assignee: SYNCMOLD ENTERPRISE CORP., NEW TAIPEI CITY (TW)

(21) Appl. No.: 13/348,743

(22) Filed: Jan. 12, 2012

(30) Foreign Application Priority Data
Oct. 14, 2011 (TW) 100137429

(51) Int. Cl. G06F 3/02; G09G 5/00

(52) U.S. Cl. 345/169; 345/156

(57) ABSTRACT

A control system capable of controlling a touch device and a method using the control system are disclosed. Specifically, the touch device may be controlled by a keyboard device or other input units of the control system external to the touch device. The control system includes a communication unit ensuring input signals delivered to the touch device are in accordance with a first predetermined communication standard and a memory unit storing a control program that is configured to switch an input mode of the control system. The touch device includes a communication unit capable of operating in accordance with the first predetermined communication standard. The disclosed method includes identifying potential control systems having at least one input unit in the neighborhood of the touch device, establishing communication between the touch device and the control system, processing the input signals, and generating corresponding input instructions.

### BACKGROUND OF THE INVENTION

1. Field of the Invention

The present invention relates to an external control system external to a touch device, and more particularly, to an external control system capable of controlling the touch device and a method using the control system.

2. Description of Related Art

As tablet computers gradually gains their popularity at least because of advantages of being smaller in size and less in power consumption. Despite the tablet computers are equipped with software-based keyboards for receiving inputs, when it comes to receiving the inputs in a large volume, however, the software-based keyboards are generally perceived not suitable.

Conventionally, specific or external physical keyboards that could be communicating with the tablet computers in accordance with wireless or wired communication standards have been developed for the tablet computers. That said, those specific and customized physical keyboards need to be carried around along with the tablet computers for providing the inputs for the same, rendering the usage of the tablet computers more cumbersome.

### SUMMARY OF THE INVENTION

The primary objective of the present invention is to provide an external control system external to a touch device. With the external control system, a keyboard device of the external control system could serve as an input means for the touch device, eliminating the need of having the customized physical keyboard carried around along with a portable touch device such as the tablet computer.

The disclosed external control system includes a central processing unit, an input/output unit, a communication unit, and a memory unit storing an operating system and a control program of the external control system.

The external control system may be switched among more than one input mode, with the control program when executed controlling transmission routes of input signals depending on the input mode in which the external control system is in.

The touch device, meanwhile, includes a signal processing unit for processing signals within the touch device, a display unit, and a communication unit capable of operating according to a first predetermined communication standard and corresponding to the communication unit in the external control system.

The touch device further includes an input signal processing unit for processing the input signals transmitted from the external control system, and a memory unit for storing an interface program that is configured to identify and locate the external control system.

The external control system may be further equipped with a signal transceiver for transmitting the input signals to the touch device according to the first predetermined communication standard while operating along with the communication unit of the external control system.

The external control system may be installed with a driver program for driving the signal transceiver, which is equipped with a switch. Depending on the operation of the switch, the control program of the external control system may determine which input mode the external control system may be in. The driver program is also configured to identify the operation of the switch in order to determine the transmission route for the signals generated from the keyboard device.

In the absence of the signal transceiver, the touch device may turn to the interface program therein and the control program in the external control system to facilitate the communication between the external control system and the touch device, and achieve the goal of enabling the external control system to provide an external input option with the touch device.

One embodiment of a method causing the external control system to serve as the input means of the touch device includes establishing the communication between the external control system and the touch device in accordance with the first predetermined communication standard, before the input signals generated from the keyboard device of the external control system could be processed by both the external control system and the touch device.

Further, after the external control system is authorized to control the touch device and the communication between the external control system and the touch device has been established, key codes generated by the keyboard device, which may be a part of the input signals, may be firstly encoded when being transmitted to the touch device. And the touch device may thereafter decode the input signals in order to obtain a corresponding input instruction, which may be further utilized to control the touch device or display characters/symbols on the display unit of the touch device.

In order to further the understanding regarding the present invention, the following embodiments are provided along with illustrations to facilitate the disclosure of the present invention.

### BRIEF DESCRIPTION OF THE DRAWINGS

FIG. 1 shows a schematic diagram of an external control system and a touch device according to one embodiment of the present invention;

FIG. 2 shows another schematic diagram of another external control system and another touch device according to another embodiment of the present invention;

FIG. 3 shows another schematic diagram of another external control system and another touch device according to another embodiment of the present invention;

FIG. 4 is a simplified block diagram illustrating a touch device, a first external control system, and a second external control system according to one embodiment of the present invention;

FIG. 5 illustrates a flow chart of a method of enabling an external control device to control a touch device according to one embodiment of the present invention;

FIG. 6 is a schematic diagram showing an external control system searching for a touch device according to one embodiment of the present invention;

FIG. 7 is a schematic diagram showing a touch device scanning for an external input means of an external computer system according to one embodiment of the present invention; and

FIG. 8 illustrates a flow chart of a method enabling an external control system to control a touch device according to one embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

The present invention also relates to a system having a touch device (e.g., a tablet without a physical keyboard, or a smart phone) and an external control system external to the touch device, with the external control system being capable of controlling the touch device. The instant disclosure further discloses a method of using the external control system in order to further operate the system having the external control system. Accordingly, the touch device could be controlled by the external control system directly without being touched. And the proposed external control system could eliminate the necessity of human operators carrying both the touch device and the traditional external keyboard when moving around. For the touch device to be controlled by the external control system, the external control system may need to be authorized to take over the control of the touch device via predetermined communication protocols/standards.

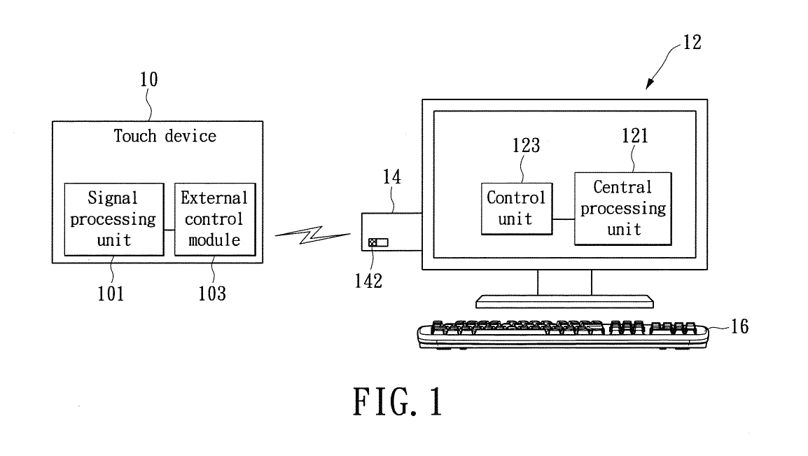

Please refer to FIG. 1 in which a schematic diagram of an external control system 12 and a touch device 10 according to an embodiment of the present invention is illustrated. The touch device 10 is communicative with the external control system 12 wirelessly. In one implementation, the external control system is a computer system having an input unit. For example, according to FIG. 1 the external control system 12 is a desktop with the traditional keyboard and a mouse. It is worth noting that the external control system 12 may be a laptop computer with a touch pad and/or a traditional keyboard.

In one implementation, the touch device 10 is another computer system with a specific operating system (OS) and generally operates when touched by the human operators despite a supportive software-based virtual keyboard may be displayed for receiving inputs from the human operators.

The touch device 10 further includes a signal processing unit 101 and an external control module 103 electrically coupled to the external control system 12 for processing input signals from the external control system 12.

The external control system 12, meanwhile, may have a signal transceiver 14 having a switch 142 implemented. The signal transceiver 14 may be a USB-based, a PCI-based, an Express-based, or a Firewire-based electronic device and inserted into the external control system 12 through a USB bus, a PCI bus, an Express-based bus, or a Firewire-based bus of the external control system 12. For the external control system 12 and the touch device 10 to be wireless communicative in accordance with a first predetermined communication standard, the signal transceiver 14 may need to be capable of the operating in accordance with the first predetermined communication standard to start with. And for the signal transceiver 14 to be operating in accordance with the first predetermined communication standard, communication software corresponding to the signal transceiver 14 may be stored in and executable by the touch device 10. With the signal transceiver 14 operating according to the first predetermined communication standard, the external control system 12 may be authorized to have the access to the touch device 10.

The external control system 12 may include an external keyboard 16, a control unit 123, and a central processing unit (CPU) 121 for controlling the operation of the signal transceiver 14. The switch 142 of the signal transceiver 14 could be a toggle switch in one implementation or a DIP switch in another implementation. The control unit 123 may receive a switching signal generated from the switch 142 so as to cause the external control system 12 to at least operate in a first input mode. When operating in the first input mode, the external control system 12 may rely on the keyboard 16 thereof as the input unit of the external control system 12. In another implementation, when operating in the first input mode the external control system 12 may provide the touch device 10 with additional input options by the signal transceiver 14. The additional input options may include the keyboard 16, the mouse of the external control system 12, and the touch pad of the same.

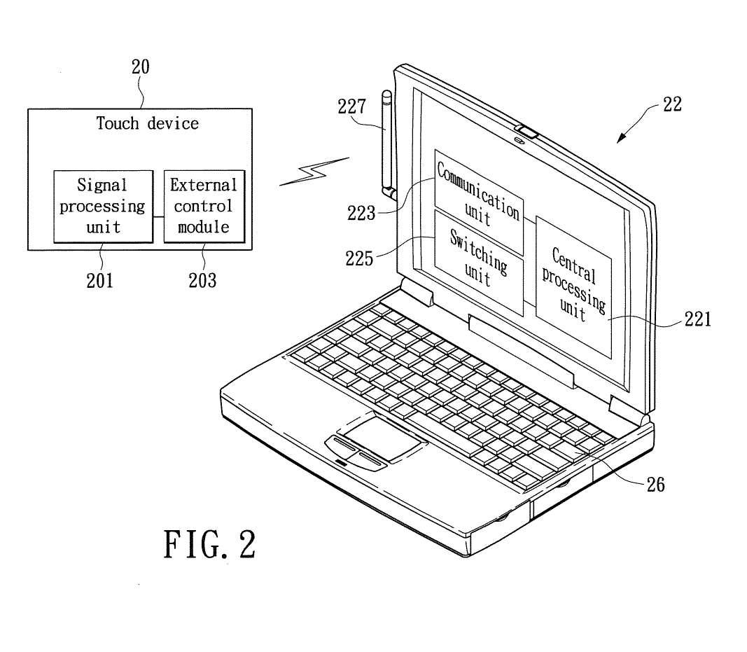

FIG. 2 illustrates another external control system 22 and another touch device 20 according to another embodiment of the present invention. Different to the external control system 12 shown in FIG. 1, the external control system 22 may be implemented in terms of software.

Specifically speaking, the touch device 20 includes a signal processing unit 201 and an external control module 203 for receiving an input signal. The external control module 203 may be software-based or alternatively hardware-based. When the external control module 203 is the software, the external control module 203 may be an interface program downloaded from a service website or an application program store.

The external control module 203 may be adapted to be in connection with circuitry or software module in the external control system 22. The external control system 22 may include a communication unit 223, which is communicative with the touch device 20 through an antenna 227 or antennas in other forms according to the first predetermined communication standard.

The external control system 22 may further include a central processing unit (CPU) 221 for processing signals within the external control system 22, a communication unit 223, a switch unit 225, and a physical keyboard 26.

The switch unit 225 may be adapted to enable the human operators to cause the external control system 22 to operate at least in the first input mode. In one implementation, the switch unit 225 may configure a hot key on the physical keyboard 26 to enable the hot key to cause the external control system 22 to operate in different input modes. In another implementation, the switching among the input modes may be realized by software so that the input mode of the external control system 22 could be displayed on a display unit before the input mode could be selected by the human operators. With the switch unit 225, the keyboard 26 or other input means such as a touch pad or a mouse could serve as the input unit of the external control system 22. Also, with the switch unit 225, the external control system 22 may provide the touch device 20 with options of the input methods including the keyboard 26, the touch pad, and the mouse of the external control system 22.

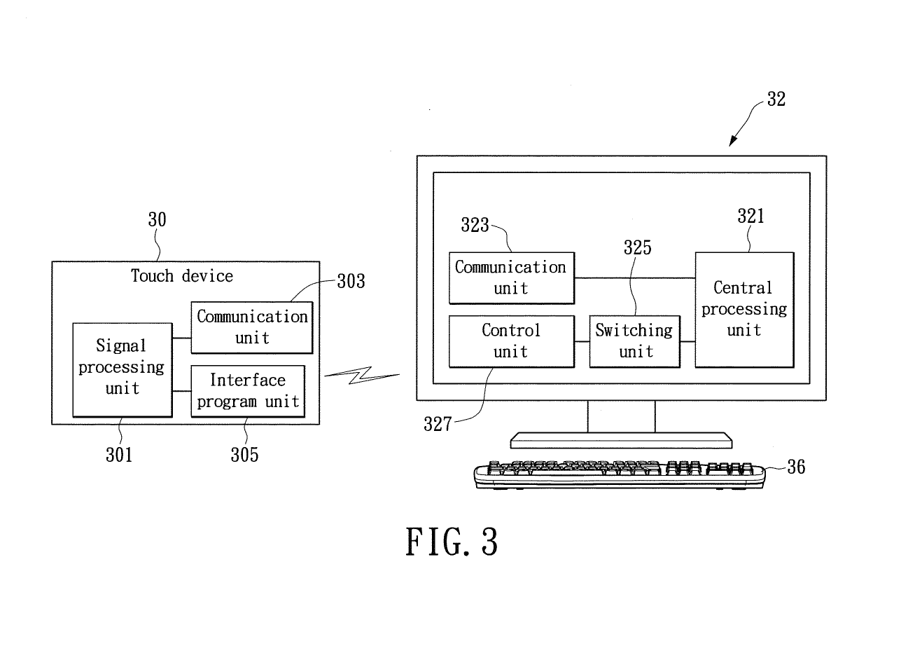

FIG. 3 shows another schematic diagram of another external control system 32 and another touch device 30 according to another embodiment of the present invention.

The touch device 30 may include a signal processing unit 301 for processing signals within the touch device 30, a communication unit 303 responsible for external communication, and an interface program unit 305 including an interface program and other related programs for enabling the touch device 30 to be controlled externally, with the interface program and other related programs stored in a memory unit (not shown in FIG. 3) of the touch device. When the interface program is executed, the wireless communication function of the touch device 30 may be enabled to search for potential external control system (e.g., the external control system 32) having input units including a keyboard 36 in the neighborhood of the touch device 30. Once the external control system 32 is located, both the external control system 32 and the touch device 30 may establish communication with each other and set up parameters for the communication (e.g., authorization configuration) and input modes.

The external control system 32 may further include a central processing unit 321 for processing signals within and from outside the external control system, a communication unit 323 for communicating with the communication unit 303 of the touch device 30, and a control unit 327 for processing input signals generated from the input unit such as the keyboard 36. In one implementation, the communication unit 323 may include a communication module implemented in terms of hardware and/or software, while the control unit 327 may be a driver circuit and/or program. For example, the control 327 may be implemented in terms of a driver for the signal transceiver in FIG. 1 or a software-based control program within the external control system 32.

Additionally, the input signals processed by the control unit 327 may be delivered to the touch device 30 or remain within the external control system 32 depending on the operation of the switch unit 325, which may be controlled by a switching signal generated from the signal transceiver or issued as the result of the inputs by the human operators.

As such, the human operators could control the touch device through the input unit of the external control system that is in the wireless communication with the touch device under the arrangement disclosed in the present invention.

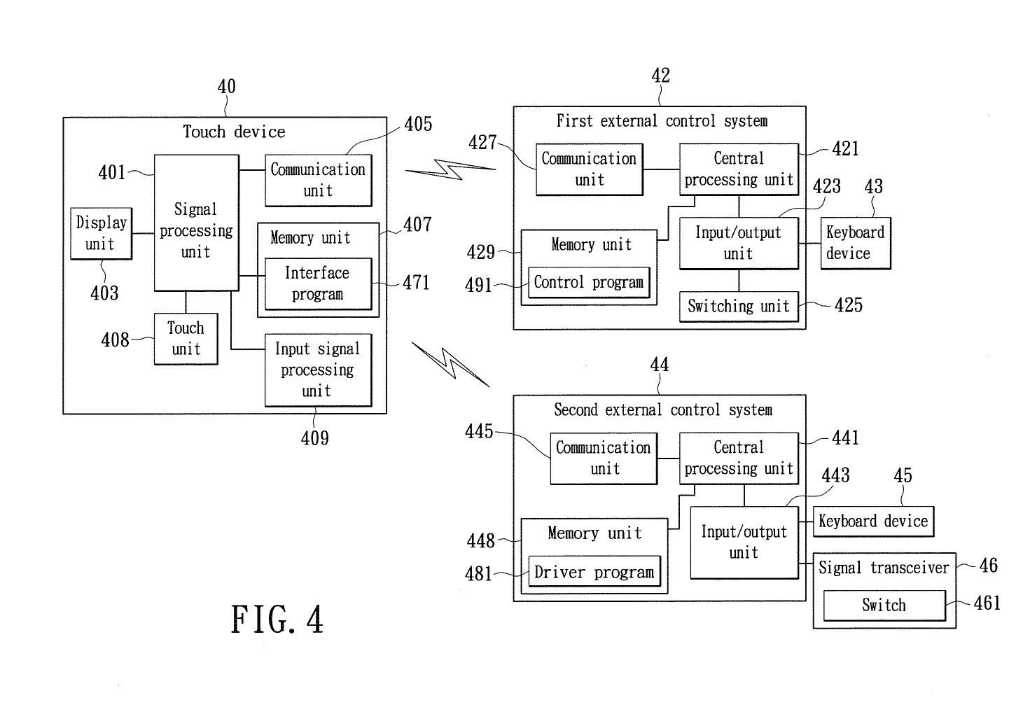

FIG. 4 illustrates a simplified block diagram showing a touch device 40, a first external control system 42, and a second external control system 44 according to one embodiment of the present invention.

In one implementation, the first external control system 42 is software-based while the second external control system 44 is implemented in terms of the corresponding software and hardware.

The touch device 40 may be capable of displaying and being touched for operation without the physical traditional keyboard. In one implementation, the touch device may be a smart phone that is not equipped with the traditional keyboard.

The touch device 40 may include a signal processing unit 401 for processing signals within the touch device 40. And it is worth noting that the signals within the touch device 40 may include the input signals transmitted from the first external control system 42 or the second external control system 44. The touch device 40 may also include a display unit 403, a communication unit 405 for communicating with communication units 427 and 445 at the first external control system 42 and the second external control system 44, respectively, and a touch unit 408 for receiving touch inputs. It is worth noting that the communication units 405, 427, and 445 may be in communication according to a first predetermined communication standard including but not limited to Bluetooth and wireless communication protocols.

The touch device 40 may further include a memory unit 407 for storing an interface program 471 that may be executed by the signal processing unit 401. The memory unit 407 may be in one implementation a non-volatile memory for further storing an operating system and corresponding software programs of the touch device 40. When the interface program 471 is executed, the first external control system 42 and/or the second external control system 44 may be identified, and the input signals may be received by the signal processing unit 409 before inputs associated with the input signal could be displayed on the display unit 403.

The first external control system 42 may include a central processing unit 421 electrically coupled to an input/output unit 423, a communication unit 427, and a switch unit 425. The switch unit 425 may be switched to generate a switching signal, which may be received by the control program 491, before an input mode for the touch device 40 could be determined and before the inputs by a keyboard device 43 could be received by the touch device 40. Alternatively, the input mode for the touch device 40 may be determined based on whether a switch 461 in a signal transceiver 46 of the second external control system 44 is enabled or not. It is worth noting that when the switch 461 is enabled a keyboard device 45 of the second external control system 44 may serve to receive the inputs for the touch device 40 through a driver program (or a driver) 481, without the execution of the control program 491 in the first external control system 42. And in order to do so the switch 461 may be a hardware-based switch, while the switching unit 425 is implemented in terms of the software.

It is also worth noting that the switch unit 425 may be also switched by the detection of human operator inputs indicative of the switching among the input modes with respect to the touch device 40.

The first external control system 42 may further include a memory unit 429 for storing an operating system for the first external control system 42 while the control program 491 may be stored in the memory unit 429 as well.

Key codes generated by the keyboard device 43 in the input signals may be either processed by the central processing unit 421 and displayed on a display unit of the first external control system 42, or delivered to the touch device 40 in accordance with a predetermined communication standard (e.g., the first predetermined communication standard) by the communication unit 427. And it is worth noting that transmission routes for the input signals may be dependent upon the operation of the switch unit 425 in the first external control system 42. Corresponding processing for the input signals should have been in the realm of the known skills of the people having the ordinary skill and is not discussed further.

In order for the input signals from the keyboard unit 43 to be successfully delivered to, processed by, and displayed on the display unit 403 of the touch device 40, the control program 491 may correspond to the interface program 491. In practice, the control program 491 may be in the same package with the interface program 471 when being placed in the stream of the commerce.

Similarly, the key codes in the input signals generated by the keyboard device 45 may be utilized by the second external control system 44 or delivered to the touch device 40 depending on whether the switch 461 is switched.

The driver program 481 stored in a memory unit 448 of the second external control system 44 may serve to drive the signal transceiver 46. As with the first external control system 42, the second external control system may be equipped with a central processing unit 441 as well.

The second external control system 44 may further include an input/output unit 443 and a communication unit 445 in addition to the memory unit 448 where the driver program 481 and an operating system for the second external control system may be stored. And the second external control system 44 may be in communication with the touch device 40 allowing for the inputs from the keyboard device 45 to be transmitted to the touch device 40 via the signal transceiver 46. In one implementation, the signal transceiver is a dongle.

For the signal transceiver 46 to be communicative with the touch device 40 when serving as an external input unit for the touch device 40, the driver program 481 may correspond to the interface program 471. When in operation, the driver program 481 may serve to control the signal transceiver 46 in order to process and transmit the key codes generated by the keyboard device 45 to the touch device 40 through the communication unit 445. Same to the control program 491, the driver program 481 may be adapted to control the transmission routes for the input signals with respect to the touch device 40, depending on the switching signal generated by the switch 461. In other words, based on the switching signal of the switch 461 the driver program 481 may be able to determine whether the inputs in the input signals from the keyboard 45 would be utilized by the second external control system 44 or delivered to the touch device 40.

Similar to the control program 491, the driver program 481 for the signal transceiver 46 of the second external control system 44 may correspond to the interface program 471. Therefore the driver program 481 may be bundled together with the interface program 471 when being put into markets, eliminating the possibility that the input signals generated by the input unit of second external control system 44 (e.g., the keyboard device 45) may not be received by the touch device 40.

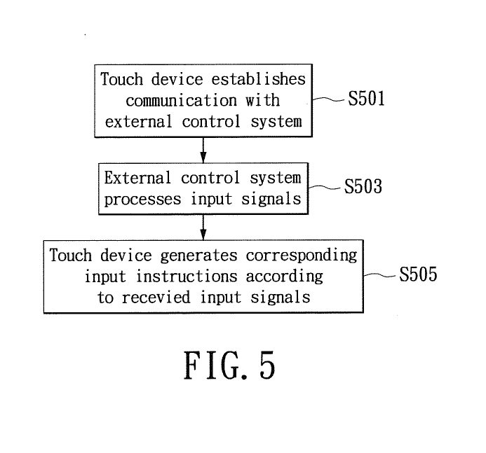

Please refer to FIG. 5 illustrating a flow chart of a method of enabling an external control device to control a touch device according to one embodiment of the present invention.

In step S501, for a touch device to be controlled by an external control system, the touch device should be in the communication with the external control system. In one implementation, the external control system may be wirelessly communicative with the touch device in accordance with the first predetermined communication standard. And the communication between the touch device and the external control system may be facilitated by the execution of the software program at both the external control system and the touch device. For example, the interface program in the touch device and the control program of the external control system may be executed in order for the external control system and the touch device to be in communication.

Once the communication between the touch device and the external control system has been established and the external system has been authorized and determines to deliver the input signals to the touch device, the input signals may be processed (e.g., encoded) in accordance with the first predetermined communication standard in step S503.

And before the communication between the touch device and the external control system could be established the touch device may be configured to scan for potential external control system in the proximity of the touch device. While the processed (or the encoded) input signals have been received by the touch device, the input signals may need to be further processed on the part of the touch device before the touch device could be controlled by the external control system from which the input signals are generated (step S503). In one implementation, the processing of the input signals at the touch device may include decoding of the input signals for the generation of input instructions. When the input instruction is a control instruction, the interface program may perform the control instruction. When the input instruction is associated with a string of characters and/or symbols, the characters and the symbols may be displayed in the display unit of the touch device.

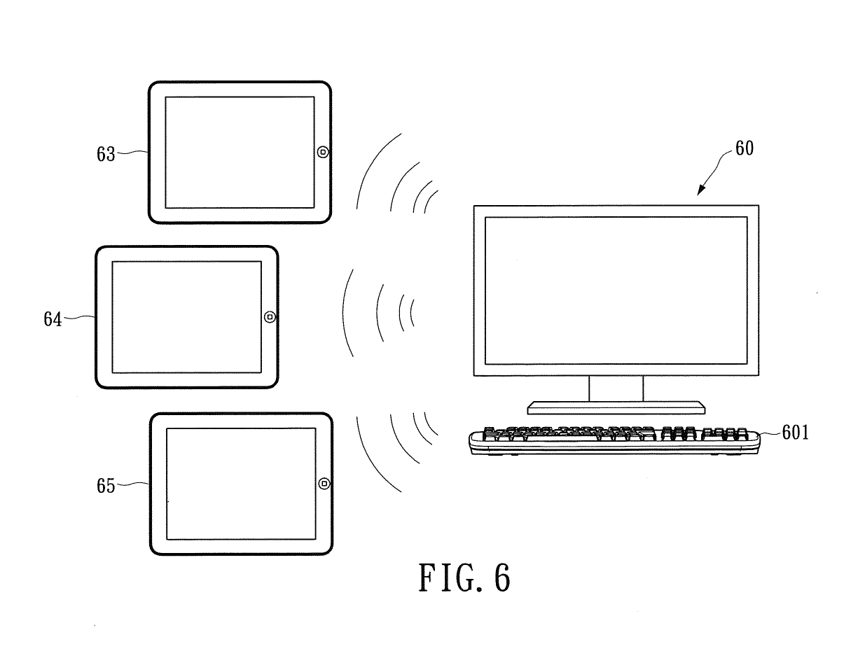

FIG. 6 is a schematic diagram showing an external control system searching for a touch device according to one embodiment of the present invention.

A computer system 60 having a physical traditional keyboard 601 as an external control system may wirelessly scan for any potential touch device in the neighborhood of the computer system 60 that could be in receipt of the input signals from the computer system 60. In FIG. 6, multiple touch devices 63, 64, and 65 may be present in the neighborhood of the computer system 60. In one implementation, the touch devices 63-65 should be within a signal transmission range of the computer system 60. And the control program or the driver program stored within the computer system 60 may be executed to locate the touch device 63-65, so that the touch device 63, 64, or 65 may be selected by the computer system 60 before the selected touch device 63, 64, or 65 could receive the input signals from the computer system 60.

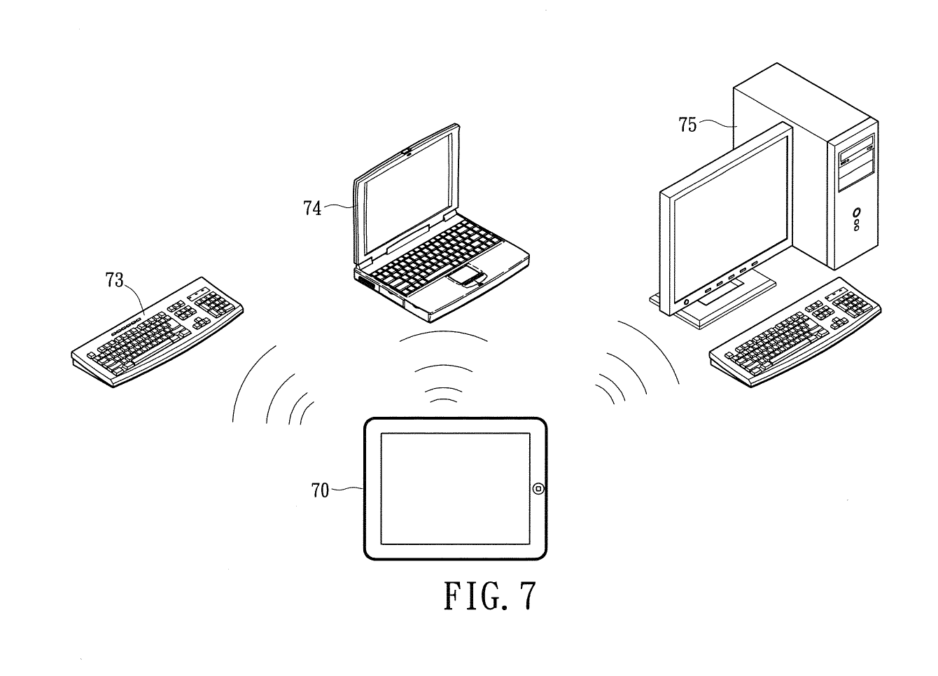

FIG. 7 is a schematic diagram showing a touch device scanning for an external input means of an external computer system according to one embodiment of the present invention.

A touch device 70 may be in the neighborhood of multiple external control systems 73, 74, and 75, each of which is with a physical traditional keyboard and/or other input units. The interface program of the touch device 70 may be executed to search for and locate the external control system 73, 74, or 75. In one implementation, the external control system 73 may be a computer system with a wireless keyboard device, while the external control systems 74 and 75 may be a laptop and a desktop, respectively.

When the external control system 73 is the external control system communicative with communication with the touch device 70 and the external control system 73 is implemented in terms of the computer system having the wireless keyboard device, a signal transceiver such as the signal transceivers 14 and 46 may be attached to the external control system 73 through a universal standard bus (USB) and may be in the wireless communication with the touch device 70. And the touch device 70 may be installed with the corresponding interface program provided by a manufacturer of the touch device 70 or download-able from application stores.

Alternatively, without the signal transceiver, the computer system having the wireless keyboard device as the external control system 73 may still be in communication with the interface program of the touch device 70 through a communication module within the computer system with the communication module having the driver program supportive of the first predetermined communication standard.

When matched, the touch device 70 may authorized the external control system 73, 74, or 75 to allow for the authorized external control system 73, 74, or 75 to serve as the input means of the touch device 70. Consequently, the authorized external control system may control the touch device 70 including causing the input signals generated from the external control system to be displayed on the touch device 70.

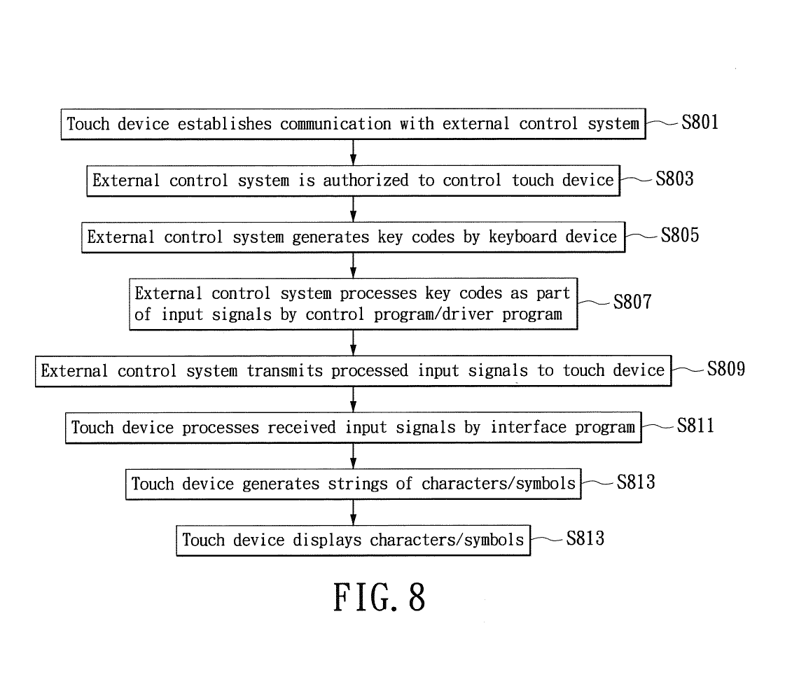

FIG. 8 illustrates a flow chart of a method enabling an external control system to control a touch device according to one embodiment of the present invention.

In step S801, the touch device may establish the communication with the external control system having the keyboard device or other input units. In order to achieve the above-mentioned goal, the interface program in the touch device and the control program or the driver program may be executed. And a one-to-one relationship may exist between the control program/driver program and the interface program. In other words, the control program/driver program may correspond to the interface program. And before the communication between the touch device and the external control system could be established, either the touch device or the external control program may search for the other in the neighborhood thereof as a potential match.

Despite the communication between the touch device and the external control system has been established, for the security concern the external control system may need to be authorized in step S803 before the input signals prepared by the external control system could be delivered to the touch device (or, in other words, the external control system may access the touch device).

In step S805, the external control system may generate the key codes from the keyboard device, which may be a part of the input signals that are processed by the control program or the driver program according to the predetermined communication standard. As previously discussed, the processing of the input signals may include encoding the key codes so that the input signals could be in compliance with the predetermined communication standard in step S807 before the input signals could be transmitted/delivered to the touch device in step S809.

Once the input signals are received by the touch device, the interface program of the touch device may decode the input signals into the corresponding input instructions in step S811, before the input instructions could serve as the basis for the touch device to be controlled by the external control system.

Accordingly, the touch device without the physical traditional keyboard may become controllable by the physical traditional keyboard externally and remotely placed in order to be totally eliminating the necessity of the touch device being equipped with the physical traditional keyboard.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A system having an external control system for a touch device, wherein (a) the touch device comprises:
a signal processing unit for processing signals within the touch device;
a display unit coupled to the signal processing unit;
a first communication unit electrically coupled to the signal processing unit and capable of operating according to a first predetermined communication standard for wirelessly communicating with the external control system in accordance with the first predetermined communication standard;
an input signal processing unit for processing an input signal from the external control system;
and a first storage unit for storing an interface program executable by the signal processing unit, and (b) the external control system comprises:
an input unit;
a central processing unit for processing signals within the external control system;
an input/output unit coupled to the central processing unit;
a second communication unit coupled to the central processing unit and capable of operating according to the first predetermined communication standard; and
a second storage unit electrically coupled to the central processing unit and for storing a control programs configured to control a transmission route of the input signal from the input unit of the external control system when the external control system operates in a first input mode;
wherein the interface program is capable of identifying the external system and configured to display an inputted content associated with the input signal from the input unit of the external control system.

2. The system according to claim 1 wherein the external control system further comprises a signal transceiver capable of operating according to the first predetermined communication standard.

3. The system according to claim 2, wherein the signal transceiver further comprises a switch when switched allowing for the control program to cause the external control system to operate in the first input mode according to an operating mode of the switch.

4. The system according to claim 3, wherein the control program comprises a driver program corresponding to the signal transceiver for identifying the operating mode and determining whether the input signal from the input unit is to be transmitted to the touch device.

5. The system according to claim 4, wherein the interface program corresponds to the signal transceiver and the driver program.

6. The system according to claim 3, wherein the external control system further comprises a display unit having a user interface presented thereon for facilitating a switching of the operating mode of the switch according to a switching instruction.

7. The system according to claim 6, wherein the interface program corresponds to the control program.

8. A method for operating a touch device from an external control system having an input unit and external to the touch device, comprising:
facilitating a wireless communication between the touch device and the external control system in accordance with a first predetermined communication standard;
enabling a compilation of an input signal transmitted from the input unit of the external control system by the touch device; and
enabling a generation of an input command according to the input signal by the touch device.

9. The method according to claim 8, further comprising having an interface program executed by the touch device, and a corresponding control program executed by the external control system in order to facilitate the wireless communication between the touch device and the external control system according to the first predetermined communication standard.

10. The method according to claim 8, further comprising having a signal transceiver inserted into the external control system for processing the input signal from the external control system to the touch device.

11. The method according to claim 10, further comprising having an interface program executed in the touch device and a driver program executed in the external control system for driving the signal transceiver.

12. The method according to claim 8, further comprising prompting the external control system to be authorized to control the touch device.

13. The method according to claim 8, wherein the input signal comprises a key code generated by the input unit and is further processed by the external control system to be in compliance with the first predetermined communication standard for facilitating the wireless communication between the control system and the touch device.

14. The method according to claim 13, wherein the interface program executed by the touch device is further adapted to process the input signal for preparing the input command.

15. The method according to claim 14, wherein when the input command is a control command the interface program is executed to perform according to the control command, and when the input command is an input character the interface program is executed to display the input character.

16. A method for operating a touch device from an external control system having a keyboard device and external to the touch device, comprising:
facilitating a wireless communication between the touch device and the external control system in accordance with a first predetermined communication standard;
enabling the external control system to be authorized to master the touch device;
enabling a generation of a key code associated with and by the keyboard device;
enabling a conversion of the key code into an input signal according to the first predetermined communication standard;
enabling a transmission of the input signal to the touch device;
enabling a processing of the input signal by an interface program of the touch device for preparing an input command; and
prompting the interface program to perform according to the input command when the input command is a control command, and prompting the interface program to display an input character in the input command.

17. The method according to claim 16, further comprising enabling a scanning for the connectable external control system in a neighborhood of the touch device by the interface program of the touch device before facilitating the wireless communication between the touch device and the external control system.

18. The method according to claim 17, further comprising enabling an exchange of an authorization data between the touch device and the control system allowing for the control system to be authorized to master the touch device, after facilitating the wireless communication between the external control system and the touch device.

19. The method according to claim 16 wherein the control program in the external control system corresponds to the interface program in the touch device.

20. The method according to claim 16 wherein the control program comprises a driver program for driving a signal transceiver inserted into the control system for enabling the transmission of the input signal to the touch device.
